(19) United States
(12) Patent Application Publication
(10) Pub. No.: US 2026/0099794 A1
(43) Pub. Date: Apr. 9, 2026

(54) AUGMENTED INTELLIGENCE (AI) DRIVEN MISSING RESERVES OPPORTUNITY IDENTIFICATION

(71) Applicant: SCHLUMBERGER TECHNOLOGY CORPORATION, Sugar Land, TX (US)

(72) Inventors: Shripad BINIWALE, Abu Dhabi (AE); Sanjoy KHATANIAR, Abingdon (AE); Mohamed Osman Mahgoub AHMED, Abu Dhabi (AE)

(21) Appl. No.: 19/113,935

(22) PCT Filed: Sep. 22, 2023
(86) PCT No.: PCT/US2023/033497

§ 371 Date: Mar. 21, 2025

Related U.S. Application Data
(60) Provisional application No. 63/409,112, filed on Sep. 22, 2022.

(51) Int. Cl. G06Q 10/0633; E21B 47/003; G06Q 50/02

(52) U.S. Cl. CPC G06Q 10/06334; E21B 47/003; G06Q 50/02

(57) ABSTRACT

A method, computer system, and computer program product are provided for identifying missing reserves in a reservoir. Well site data for well sites in a reservoir are ingested. A first machine learning model generates behind casing opportunities and reservoir quality indicators from the plurality of logs. A second machine learning model determines missing reserves based on the reservoir quality indicators for the well sites and in between the wells. A third machine learning model determines candidate wells based on the missing reserves. A fourth machine learning model predicts economic outcomes for intervention options for the candidate wells. An oilfield decision is supported based on the predicted economic outcomes.

### CROSS REFERENCE TO RELATED APPLICATIONS

This application is a nonprovisional application of, and thereby claims benefit to, U.S. Provisional application 63/409,112 filed on Sep. 22, 2022, which is incorporated herein by reference in its entirety.

### BACKGROUND

Reserves are those quantities of petroleum which are anticipated to be commercially recovered from known accumulations from a given date forward. Identification of new reserves is a main focus for oil & gas company for long-term sustenance. Identifying reserves involves integration between various disciplines, such as subsurface data, petrophysical information, reservoir models, and production data. Reserves estimates will be revised as additional geologic or engineering data becomes available or as economic conditions change.

However, traditional techniques either to find new reserves or to identify missing reserves are both labor intensive and time intensive, due to, for example, the large amount of data, availability of reservoir models, lack of integration, and lack of insights. For example, a vast amount of data is generated and collected during field production. Consumption and analysis of this data to identify reserve opportunities often uses a manual examination of the data that is both a resource-intensive and mundane. Traditional subsurface, reservoir, and petrophysical analysis is time-intensive and lacks new insights due to manual and mundane tasks.

Further, building accurate reservoir models is a resource-intensive process, often relying on the integration of multiple analysis platforms. The integration often uses a collaboration of domain experts to work together throughout the process. Due to a lack of data flow and the resource-intensive nature, reservoir models are not available or not up to date hindering further analysis.

### SUMMARY

In general, in one aspect, one or more examples relate to a method for identifying missing reserves in a reservoir. The method includes ingesting logs of well site data for well sites in a reservoir. The method also includes generating, by a first machine learning model, a plurality of behind casing opportunities from the plurality of logs. The method further includes determining, by a second machine learning model, missing reserves based on the reservoir quality indicators for the plurality of well sites. The method additionally includes determining, by a third machine learning model, candidate wells based on the missing reserves. The method further includes predicting, by a fourth machine learning model, economic outcomes and for ranking a plurality of intervention options for the candidate wells. The method also includes controlling an oilfield decision based on the predicted economic outcomes.

Other aspects of the invention will be apparent from the following description and the appended claims.

### BRIEF DESCRIPTION OF DRAWINGS

FIG. 1 depicts a cloud-based data sharing environment in which one or more embodiments may be implemented.

FIG. 2 shows a computing system in accordance with one or more embodiments of the invention.

FIG. 3 shows a machine learning framework in accordance with one or more embodiments of the invention.

FIG. 4.1, 4.2, and 4.3 illustrates a transformer architecture in accordance with one or more embodiments of the invention.

FIG. 5 shows a flowchart in accordance with some embodiments of the invention.

FIGS. 6, 7, 8, 9, 10, 11, and 12 show examples in accordance with some embodiments.

FIG. 13.1 and 13.2 shows a computing system in accordance with some illustrative embodiments.

Like elements in the various figures are denoted by like reference numerals for consistency.

### DETAILED DESCRIPTION

In general, embodiments are directed to a decision support system and methodology that uses Augmented Intelligence (AI) driven technique for identification of missing reserves. Augmented Intelligence is an alternative conceptualization of artificial intelligence that leverages machine learning and data analytics to process vast amounts of data and improve human intelligence. The illustrative embodiments use the concept of AI to accelerate an automatic identification of missing reserves. The decision support system is divided into two parts-a ‘Planning’space and an ‘Operational’space.

The ‘Planning’ stage integrates multiple decision stages for automated quick identification of opportunities in missing reserves. Opportunity Assessment, Data Discovery & validation, ML-assisted opportunity identification, and ML-based RQI (Reservoir quality indexation) & well contribution space.

The ‘Operational’ space integrates multiple decision stages for the identification of target spots, ranking, and evaluating options through an AI platform to support the expert decision. Data-driven target spot analysis, Production assessment & predictive analytics, Risk/cost, and AI for missing reserves opportunity. The solution also proposes intervention opportunities that can assist the ‘Operational’space while managing uncertainty and risks.

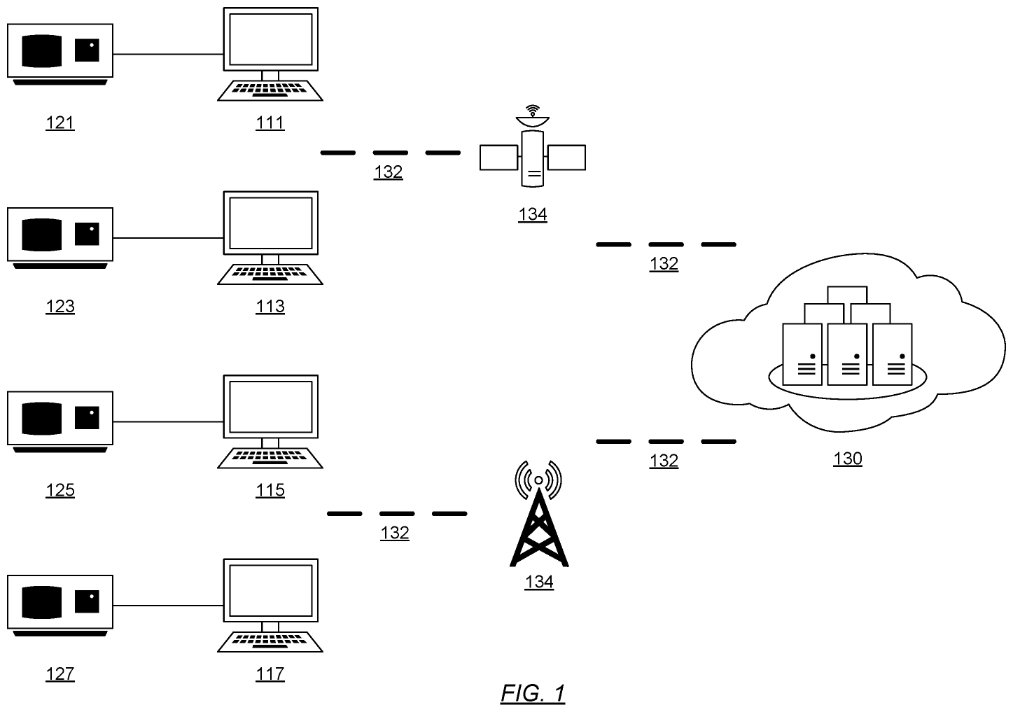

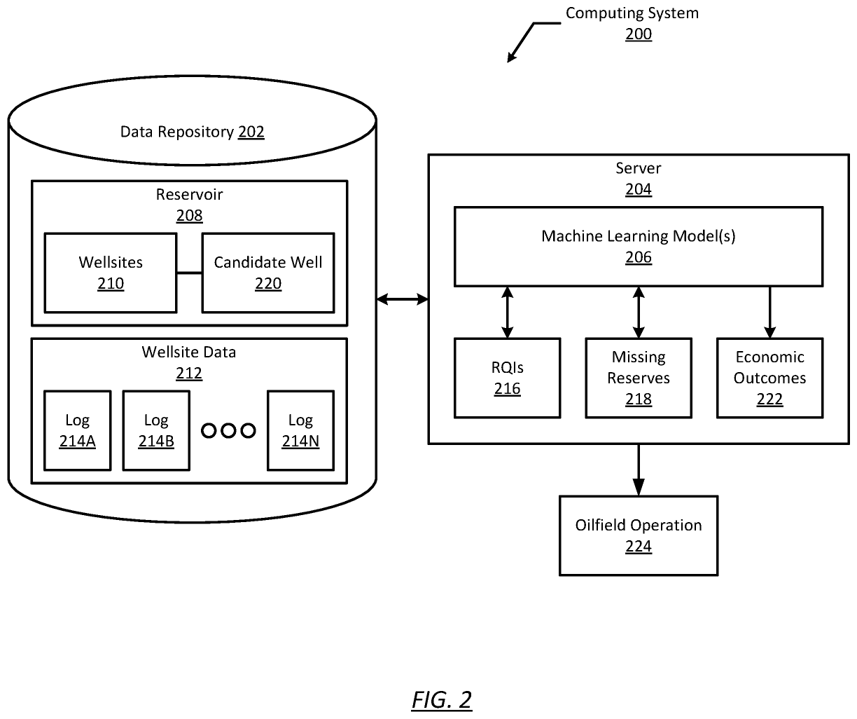

FIG. 1 depicts a cloud-based data sharing environment in which one or more embodiments may be implemented. In one or more embodiments, one or more of the modules and elements shown in FIG. 1 may be omitted, repeated, and/or substituted. Accordingly, embodiments should not be considered limited to the specific arrangement of modules shown in FIG. 1.

As shown in FIG. 1, the data sharing environment includes remote systems (111), (113), (115), (117), data acquisition tools (121), (123), (125), (127), and a data platform (130) connected to the data acquisition tools (121), (123), (125), (127), through communication links (132) managed by a communication relay (134).

In one or more embodiments, data acquisition tools (121), (123), (125), and (127) are configured for collecting data. In particular, various data acquisition tools are adapted to measure and detect the physical properties of physical objects and structures. Other data may also be collected, such as historical data, analyst user inputs, economic information, and/or other measurement data and other parameters of interest.

In one or more embodiments, the remote systems (111), (113), (115), (117), are operatively coupled to the data acquisition tools (121), (123), (125), (127), and in particular, may configured to send commands to the data acquisition tools and to receive data therefrom. The remote systems (111), (113), (115), (117) may therefore be provided with computer facilities for receiving, storing, processing, and/or analyzing data from the data acquisition tools. In one or more embodiments, the remote systems may also be provided with, or have functionality for actuating, mechanisms of the data acquisition tools (121), (123), (125), (127). A data acquisition tool may be located in a physical location that differs from that of the remote system. As an example, a location may be, for example, a processing facility location, a data center location (e.g., server farm, etc.), an oil rig location, a well site location, a wind farm, a solar farm, etc. In one or more embodiments, the remote systems may then send command signals in response to data received, stored, processed, and/or analyzed, for example, to control and/or optimize various operations of the data acquisition tools.

In one or more embodiments, the remote systems (111), (113), (115), (117) are communicatively coupled to the data platform (130) via the communication links (132). In one or more embodiments, the communication between the remote systems and the data platform may be managed through a communication relay (134). For example, a satellite, tower antenna or any other type of communication relay may be used to gather data from multiple remote systems and transfer the data to a remote data platform for further analysis. In one or more embodiments, the data platform is an E&P system configured to analyze, model, control, optimize, or perform management tasks of E&P field operations based on the data provided from the remote systems. In one or more embodiments, the data platform (130) is provided with functionality for manipulating and analyzing the data. In one or more embodiments, the results generated by the data platform may be displayed for user to view the results in a two-dimensional (2D) display, three-dimensional (3D) display, or other suitable displays. Although the remote systems are shown as separate from the data platform in FIG. 1, in other examples, the remote systems and the data platform may also be combined.

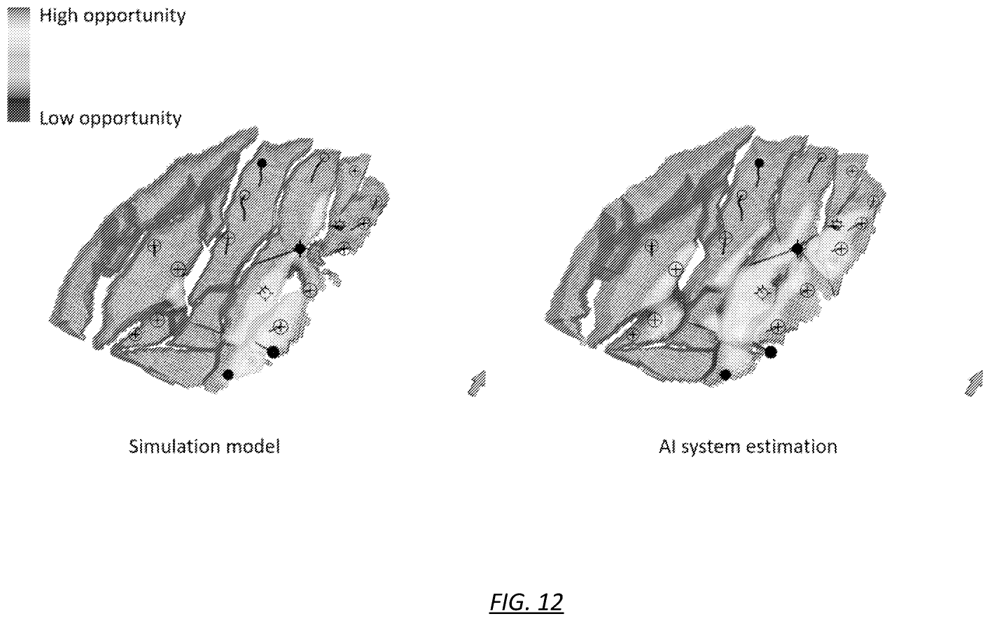

In one or more embodiments, the data platform (130) is implemented by deploying applications in a cloud-based infrastructure. As an example, the applications may include a web application that is implemented and deployed on the cloud and is accessible from a browser. Users (e.g., external clients of third parties and internal clients of to the data platform) may log into the applications and execute the functionality provided by the applications to analyze and interpret data, including the data from the remote systems (111), (113), (115), (117). The data platform (130) may correspond to a computing system, such as the computing system shown in FIG. 12.1 and 12.2 and described below.

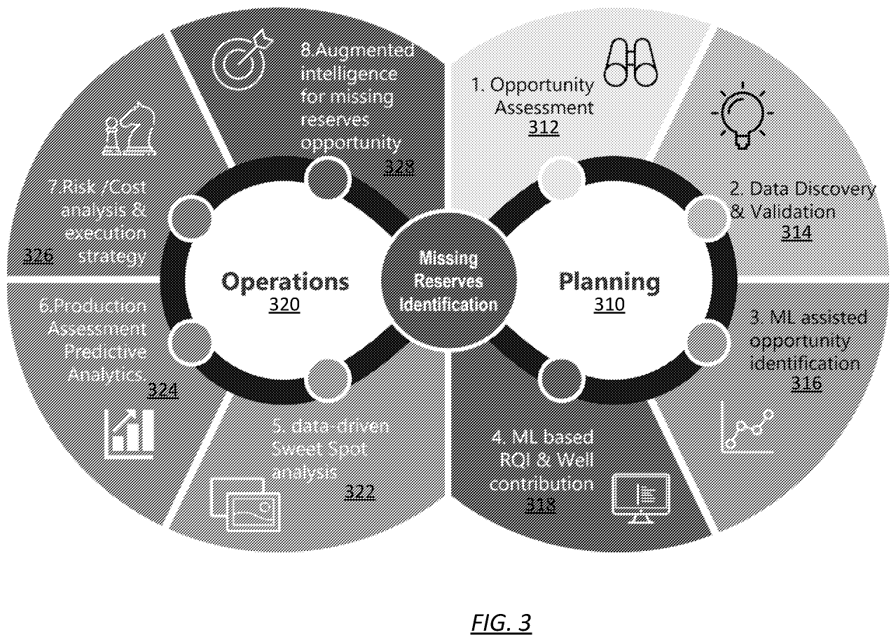

FIG. 2 shows a computing system (200), which may be the same as a computing system of data platform (130) in FIG. 1. The hardware components of computing system (200) are described in further detail below and in FIG. 12.1 and 12.2. The computing system includes a data repository (202), and a server (204) running one or more machine learning model(s) (206).

According to illustrative embodiments, the computing system (200) overcomes one or more challenges in identifying missing reserves by providing an integrated approach for multi-domain analysis and evaluation. Compared to other known analytical techniques in a traditional siloed domain, the system combines digital technologies such as data analytics and artificial intelligence (AI)/machine learning (ML) techniques together with expert advisory system. The system enables new insights for opportunity that is scalable across multiple platforms to optimize mature field operations with greater decision confidence in a shorter decision cycle time.

In one or more embodiments of the invention, the data repository (202) is any type of storage unit and/or device (e.g., a file system, database, data structure, or any other storage mechanism) for storing data. Further, the data repository (202) may include multiple different, potentially heterogeneous, storage units and/or devices.

The data repository (202) stores data related to at least one reservoir (208) serviced by one or more well sites (210). Well sites (210) can be associated with a rig, or a production equipment, a wellbore, and other well site equipment configured to perform wellbore operations, such as logging, drilling, fracturing, production, or other applicable operations. For example, a well site can be associated with a rig, a wellbore, and drilling equipment to perform a drilling operation. A well site may be associated with a surface storage tank and/or transport pipeline to perform production operations.

The well sites (210) may be operatively coupled to the data acquisition tools (121), (123), (125), (127) of FIG. 1. In particular, the data acquisition tools (121), (123), (125), (127) of FIG. 1 may generate well site data (212) for E&P operations which is stored as one or more logs (214A, 214.2, 214N) in data repository (202).

Well site data (212) can include drilling data, such as drilling rate, depth measurements, fluid properties and composition, bit, and drill string parameters (e.g., torque, weight on bit), and mud logging data, including gas content and lithology. Well site data (212) can include geological data, such as formation evaluation data (e.g., resistivity and porosity measurements), core samples and cuttings analysis, as well as Seismic and well log data for subsurface imaging. Well site data (212) can include pressure and temperature data, such as wellbore pressure and temperature measurements, pore pressure and fracture gradient data, as well as annular pressure measurements during drilling and well control operations.

Well site data (212) can include current production data, such as flow rates (e.g., oil, gas, and water produced), wellhead pressure and temperature. Well site data (212) can include production history and decline current data, such as historical production rates and volumes, including analysis of well performance over time, reservoir pressure and productivity indices, drawdown/buildup data, and flowmeter measurements.

The system shown in FIG. 2 also may include a server (204). The server (204) is one or more computing systems operating in a possibly distributed computing environment. The data repository (202) may be local (sharing the same physical location) to the server (204) or may be remote from the server (204). The server (204) may be the computing system, and may include the network environment, of the computing system shown in FIG. 12.1 and FIG. 12.2.

The server (204) includes one or more machine learning model(s) (206). A machine learning model(s) is a computer program that has been trained to recognize certain types of patterns. Many distinct types of machine learning models exist, though broadly, machine learning models are categorized into supervised and unsupervised machine learning models, which relate to how the machine learning models are trained. A supervised machine learning model(s) is trained based on known data that is compared to the output of the machine learning model(s) during training. An unsupervised machine learning model(s) is trained without known data during training. One or more embodiments may use either supervised or unsupervised machine learning models.

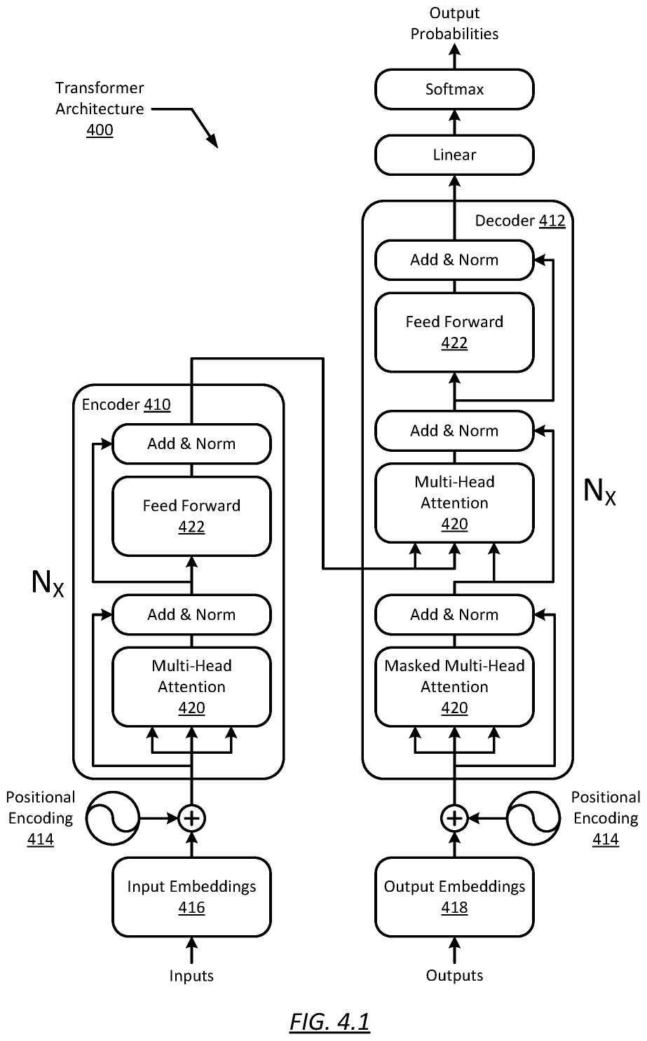

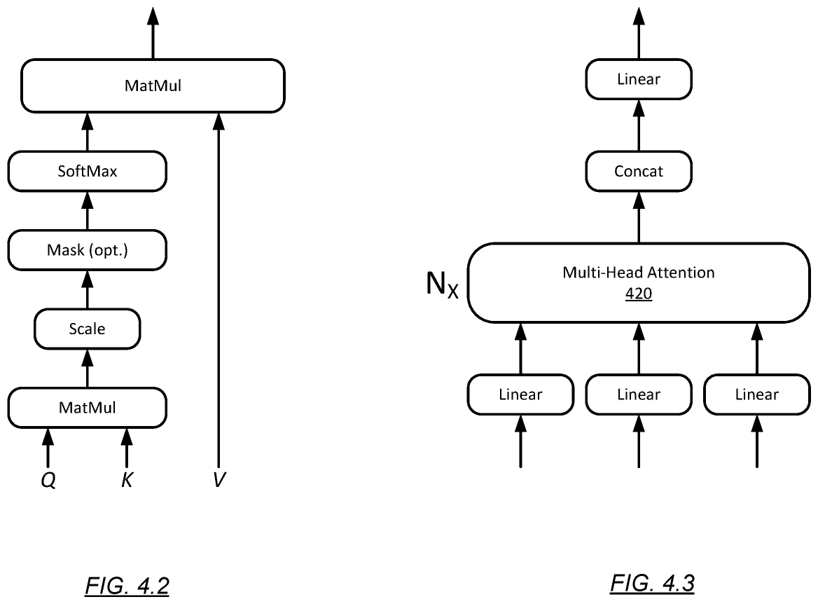

In an example, the machine learning model(s) (206) is a neural network model that employs a transformer architecture, such as shown in FIG. 4.1-4.3. In this example, the machine learning model(s) (206) is trained on well site data (212). Training a machine learning model(s) changes the machine learning model(s) by changing the parameters defined for the machine learning model(s). Thus, once changed, a machine learning model(s) may be referred-to as a “trained” machine learning model(s). A trained machine learning model(s) is different than the untrained machine learning model(s) because the process of training transforms the untrained machine learning model(s). The training may be an ongoing process. Thus, a trained machine learning model(s) may be retrained and/or continually trained. Further, an untrained machine learning model(s) may be a pre-trained machine learning model(s) that has a certain amount of training performed.

In an example, the machine learning model(s) (206) may utilize various machine learning algorithms such as linear, non-linear, tree-based and boosting algorithms that have been evaluated with the available dataset to optimize overall errors, median values, and blind test results. For example, in some embodiments. The machine learning model(s) (206) may comprise a Random Forest Classifier, Convolutional Neural Network and/or Light Gradient Boosting Machine Classifier.

In an example, reservoir quality indicators (RQI) (216) are a parameter or set of parameters generated by the machine learning model(s) (206) from well site data (212). Reservoir quality indicators (RQI) (216) can be derived from well logs and include, for example, average porosity, average permeability, net pay thickness, flow capacity, water saturation, hydrocarbon storage capacity, and permeability/porosity, as well as other user defined RQIs. The indicators are used to assess the quality of a subsurface reservoir rock, particularly in terms of its suitability for the accumulation and production of hydrocarbons (oil and natural gas).

In an example, missing reserves (218) are predictions generated by one of the machine learning model(s) (206) from the reserve quality indicators (216) from the well site data (212). More generally, the term “missing reserve” refers to hydrocarbon reserves that are expected to exist in a given reservoir but have not been discovered or quantified through exploration and drilling activities.

FIG. 2 illustrates the overall process flow. For machine learning modeling purposes, the missing reserves can be divided in 2 categories. In the first category, the missing Reserves can be identified as Behind Casing opportunities (BCO), where pay not registered as hydrocarbon-bearing when well sites (210) were drilled and pay registered as hydrocarbon-bearing when well sites (210) were drilled but not produced due to completion strategy. In the second category, the Missing Reserve can be identified between wells using Seismic, 3D datasets, core measurements with the various reservoir properties such as lithology, porosity, and water saturation.

The machine learning model consumes the provided input such as physical parameters from the log (214), well information and well properties data for well sites (210) for the candidate wells (220). Machine learning quickly performs quality control and conditioning of the log data, predicts new log data by filling in the missing information or the missing zones and provided newly constructed log. These generated logs are used to find BCOs for missing intervals which potentially can be produced within the well sites (210). In addition, the generated logs can be combined with well properties data such as core measurement data, special core analysis to produce RQI (216) for each well and intervals within the wells. The machine learning model(s) (206) uses RQI information and analyze against average production of the wells and intervals within the wells to produce a second set of missing reserves. The machine learning model(s) (206) can map the potential zones in between the well sites (210) to provide potential opportunities for missing reserves (218).

In some embodiments, candidate well (220) can be one of well sites (210) that is identified by machine learning models (206) based on missing reserves (218). For example, candidate well (220) may be targeted, by one of machine learning levels (206), for intervention based on a comparison of RQIs against production performance to identify work over candidate wells which have good reservoir quality and bad production performance. Analysis can be performed at both the well and completion levels. Production performance indicators can include data such as cumulative oil/gas production and peak production rate.

In some embodiments, candidate well (220) can be an area between well sites (210) that is not developed and/or is not producing. For example, using machine learning-based reservoir property generation for the areas between well sites (210) with missing logs or missing physical measurements, machine learning model(s) (206) can help to identify missing reserves opportunities in between the well sites (210). Economic outcomes (222) are predictions by the machine learning models for a plurality of intervention options for the candidate wells. For example, taking the candidate well (220), together with data regarding interventions performed at other well sites (210), machine learning model (206) may perform probabilistic data-driven reservoir simulation to estimate the amount of oil or gas produced by each well, i.e., the value of each well after a performing an intervention. The costs of creating and operating the new and existing wells are also considered. These costs and values can then be combined to compute the Net Present Value (NPV) of each well and hence the discounted profitability index (DPI) for the entire field based on determined workover options.

Turning to FIG. 3, a machine learning framework is shown according to illustrative embodiments. The framework illustrated in FIG. 3 may be implemented using the machine learning model(s) (206) of FIG. 2.

As illustrated, the framework of FIG. 3 provides a decision support system and methodology that uses an Augmented Intelligence (AI) driven technique for identification of missing reserves. Augmented Intelligence is an alternative conceptualization of artificial intelligence that leverages machine learning and data analytics to process massive amounts of data and improve human intelligence. The illustrative embodiments use AI to accelerate the automatic identification of missing reserves.

The decision support system is divided into two parts-a Planning (310) space and an Operational (320) space. The Planning (310) integrates multiple decision stages for automated quick identification of opportunities in missing reserves. The Operational (320) integrates multiple decision stages for the identification of target spots, ranking, and evaluating options through an AI platform to support the expert decision.

Planning (310) includes Opportunity Assessment (312), Data Discovery & validation (314), machine learning-assisted opportunity identification (316), and machine learning-based RQI (Reservoir quality indexation) & well contribution space (318).

As shown, Opportunity Assessment (312) receives available well site data from a data repository, such as the data repository (202) of FIG. 2. The data includes well site data collected from and/or generated by a number of data sources for E&P operations. For example, the data can include production data (monthly), pressure/volume/temperature (PVT) data, top structure maps, volumetric maps (including hydrocarbon pore volume (HCPV), pore volume distribution (PVD), net volume (NV), gross rock volume (GRV)), faults and aquifer locations, permeability trends, reservoir pressures, well trajectories (X, Y, Z), well tops, well events (including zone open/close), well log data, routine core analysis (RCA) data, and Special Core Analysis Data (SCAL) such as relative permeability, capillary pressure, wettability.

Focusing on available data that was collected from the various data sources, the data is input to a number of discovery and validation models (314), discovery and validation models (314) employ one or more machine learning algorithms focused on data collection and curation from the various data sources, including operations such as data preparation, outlier detection, data transformation, and recreation of missing data.

According to illustrative embodiments, discovery, and validation models (314) can review and process the available data using one or more data analytics, AI/machine learning (ML) techniques, and domain experts-guided system. Discovery and validation models (314) may leverage various reservoir simulation and software frameworks, such as Petrel, Techlog, as well as various machine learning frameworks, such as Dataiku, Python & Jupiter notebook.

According to illustrative embodiments, discovery, and validation models (314) may predict reservoir properties directly from measurements such as effective porosity (PHIE), total porosity (PHIT), permeability (PERM), volume of shale in a volume of rock (VSHALE), and/or surface well testing (SWT).

For example, discovery and validation models (314) may derive missing feature values from known information about the data distribution of the feature. For categorical features, missing values may be replaced by the most common value for that feature (e.g., the mode value of the feature). In addition, one hot encoding may be applied to categorical features to facilitate consumption by the machine learning model. For numerical features, missing values may be replaced with the value corresponding to the 50th percentile of that feature (e.g., the median value of the feature). To account for possible typographical and/or input errors, outlier values may be removed from numerical features. For example, removing outliers removed less than 1% of the training data in a sample training dataset.

Discovery and validation models (314) may perform cross validation and oversampling, for example, using a synthetic minority over-sampling technique (SMOTE). The cross-validation procedure may be applied to calculate the accuracy of the prediction using training and validation datasets. For example, discovery and validation models (108) may apply a modified SMOTE oversampling technique to the training dataset to help reduce data imbalance for one or more tasks.

Output from discovery and validation models (314) is sent to one or more opportunity identification models (316) to perform various machine learning assisted workflows, such as machine learning-assisted log quality control (QC), /and machine learning-driven behind casing opportunities (BCO), machine learning-based reservoir quality indicators (RQI) and well contribution, and data-driven target spot analysis.

As used herein, a workflow may be a process that includes a number of work steps. A work step may operate on data, for example, to create new data, to update existing data, etc. As an example, a system may operate on one or more inputs and create one or more results, for example, based on one or more algorithms. A workflow may include one or more work steps that access a module such as a plug-in (e.g., external executable code, etc.). A workflow may be implementable in the various reservoir simulation and machine learning software frameworks to operates on data (102), including frameworks such as Petrel, Techlog, Dataiku, Python & Jupiter notebook.

Opportunity identification models (316) uses machine learning-assisted log QC model that is applied to automatically assist conditioning workflows for data curation, making data available across legacy systems and reducing uncertainty. The machine learning model consumes the provided input such as physical parameters from the log measurement, interpreted values, oil saturation for well intervals. Machine learning quickly performs quality control and conditioning of the log data to assess the quality of physical properties such as porosity, permeability, VSHALE, and saturation. Machine learning algorithms predict new log data by filling the missing information or the missing zones and provided newly constructed log. Machine learning model uses several such logs and performs interpretation of zones between the wells with possible connectivity of zone between the wells.

Opportunity identification models (316) can include a machine learning driven BCO that uses outputs from previous machine learning Log model. For the interval of interest if the quality trust factor is high the model uses that information, to flag or identify hydrocarbon intervals behind casing using Machine Learning. In the case of the low-quality trust factor, the model uses its own machine learning prediction module for the property prediction of the interval. In both cases machine learning model will identify missing behind casing interval opportunities (BCO) which is previously unaccounted or identified as null but have potential.

machine learning based RQI and well contribution models (318) evaluate reservoir quality indicators (RQI) for wells. The indicators can be derived from well logs and include, for example, average porosity, average permeability, net pay thickness, flow capacity, water saturation, hydrocarbon storage capacity, and permeability/porosity, as well as user defined RQIs.

The trained machine learning models mentioned above use BCO, RQI and well deliverability to highlight the specific zonal level opportunity for high-quality remaining reserves. However, instead of one deterministic case used traditionally machine learning model creates hundreds of realizations by parameterizing the property values above and below the actual or predicted values providing a probabilistic map of scenario distribution. This is further used to create a stochastic remaining oil-in-place map and can be visualized in 3D geological model. It replaces the effort of running a dynamic simulation model by machine learning proxies, within a fraction of the time.

Operational (320) includes Data-driven sweet spot analysis (322), Production assessment & predictive analytics (324), risk/cost and AI for missing reserves opportunity (326). The solution also proposes interventions to identify missing reserves opportunities (328) that can assist the ‘Operational’ space while managing uncertainty and risks.

Data-driven target spot analysis (322) are one or more machine learning algorithms to perform candidate screening and candidate ranking. For the existing wells, it uses a machine learning driven BCO model to highlight the potential production that can be achieved from a specific well and also specifies which interval or pay zone has potential. In this case, the missing reserves can be produced from existing perforation, or a new pay zone can be perforated for production enhancement.

Data-driven target spot analysis (322) also leverages machine learning-based RQI for the identification of missing reserves in between the wells using RQI, well-to-well pay zone correlation, and available reservoir information. It identifies specific pay zones between the wells and generates the location of one or more drilling sites or “target spots” within a field. Machine learning generates various ensembles, meaning realizations with permutation & combination of all the reservoir properties, and provides hundreds of such maps of possible missing locations with a probability of success. The performance of this is significantly improved by generating machine learning simulations on the cloud with flexible computing capabilities resulting in very quick analysis of such scenarios.

As used herein, “target spots” or “sweet spots” are possible drilling sites having advantageous combinations of various geological, geochemical, and petrophysical characteristics that may indicate prospective hydrocarbon zones over the field's subterranean domain.

Production assessment & predictive analytics (324) are one or more machine learning algorithms to compare RQIs against production performance indicators, and to identify work over candidate wells which have good reservoir quality and bad production performance. Production performance indicators can include data such as cumulative oil/gas production and peak production rate. Analysis can be performed at both the well and completion levels.

For example, underperformance identification can be based on a production heterogeneity analysis comparing the behavior of individual wells in a group using the average behavior of the wells as a reference. The comparison can be based on a modified heterogeneity index—a dimensionless calculated variable defined as:
Wherein:
MHI=Modified heterogeneity index;
VALUE_{Group.Avg}=Arithmetic average of all selected wells at current time step;
VALUE_{MaxWell}=Maximum value at current time step among all selected wells; and VALUE_{MinWell}=Minimum value at current time step among all selected wells.

Risk/cost and AI for missing reserves opportunity (326) are one or more machine learning algorithms to perform probabilistic reservoir simulation to estimate the amount of oil or gas produced by each well, i.e., the value of each well. The costs of creating and operating the new and existing wells are also considered. These costs and values can then be combined to compute the Net Present Value (NPV) of each well and hence the discounted profitability index (DPI) for the entire field based on determined workover options.

One or more embodiments also proposes intervention opportunities (328) that can assist the ‘Operational’ space while managing uncertainty and risks. For example, the platform can be connected to an interface (e.g., user interface, application programming interface) that enables access to one or more missing reserves opportunities (328) predicted for a selected region. These missing reserves opportunities (328) are then used to see the impact on production enhancement & predictive analytics, with a risk/cost analysis being performed to determine the return on investment. A domain expert-guided system can be employed to identify and finalize the missing reserves opportunity based on the processed data.

FIG. 4.1-4.3 illustrates a transformer architecture. Transformer architecture (400) can be used to implement machine learning model(s) (206) of FIG. 2. The transformer, in comparison to recurrent neural networks (RNN), is less prone to suffering from the vanishing gradient problem which is characteristic of networks using gradient-based optimization techniques (i.e., reduced efficacy due to the earlier layers learning being slower than the learning of later layers due to temporal information decay).

The transformer architecture (400) relies on a self-attention (intra-attention) mechanism, thereby eliminating the recurrent operations computed in Recurrent Neural Networks, which may be used to compute the latent space representation of both the encoder (410) and decoder (412) sides. Positional encoding (414) is added to the input and output embeddings (416, 418) with the absence of recurrence. The positional information, which is similar to a time-step in a recurrent network, provides the Transformer network with the order of input and output sequences. A combination of absolute positional encoding and relative positional information may be used. Input from the previously generated symbol is auto-regressively used by the model for the next prediction which is organized as a stack of encoder-decoder networks. In addition, uniform layers compose both the encoder (410) and decoder (412), and each layer is built of two sublayers: a multi-head self-attention layer (420) and a position-wise feed-forward network (FFN) layer (422). The multi-head sub-layer (420) enables the use of multiple attention functions with an equivalent cost of utilizing attention, while the FFN sub-layer (422) uses a fully connected network to process the attention sublayers. The FFN applies multiple linear transformations on each position and a Rectified Linear Unit (ReLU) which extends the self-attention mechanism to efficiently consider representations of the relative positioning (i.e., distances between sequence elements).

FIG. 4.2 and FIG. 4.3 illustrate a multi-head attention head architecture in accordance with one or more embodiments. Multiple attention heads (FIG. 4.2) can be combined to form the multihead attention (FIG. 4.3) that can be implemented in the transformer architecture (400) of FIG. 4.

As illustrated in FIG. 4.2, an attention function can be described as mapping a query and a set of key-value pairs to an output, where the query, keys, values, and output are all vectors. The attention head is initialized with a set of weights that will be learned during training to assign different weights to various parts of the input sequence.

The attention head computes three vectors for each position in the input sequence: query (Q), key (K), and value (V). In “encoder-decoder attention” layers, the queries come from the previous decoder layer, and the memory keys and values come from the output of the encoder. The query (Q) vector represents the position being considered, while the key (K) and value (V) vectors represent all other positions in the sequence. These vectors are obtained by multiplying the input sequence with learnable weight matrices, which are unique for each of the query, key, and value vectors. The queries, keys, and values are packed together into matrices, which provide input to the various linear functions. This allows every position in the decoder to attend over all positions in the input sequence.

A similarity score is calculated between the query vector and all key vectors in the sequence. The attention functions can be multiplicative, by computing the dot product between the query vector and each key vector. Alternatively, an additive function can be used, wherein the compatibility function may utilize a feed-forward network with a single hidden layer. The resulting scores can be normalized using a scaling factor.

For each position in the sequence, an attention score is computed by applying the SoftMax function to the obtained similarity scores. The attention scores represent the weights assigned to each position in the sequence, indicating how much attention should be given to that position.

A weighted sum of the value vectors is then calculated using the attention scores. This summation results in a single output vector, which represents the weighted combination of all value vectors in the sequence. In other words, the output is computed as a weighted sum of the values, where the weight assigned to each value is computed by a compatibility function of the query with the corresponding key.

Multi-head attention (FIG. 4.3) allows the model to jointly address information from different representation subspaces at various positions. The queries, keys and values are projected h times with different, learned linear projections according to matrices dimensions. The attention function is performed in parallel on each of these projected versions of queries, keys, and values, yielding dv-dimensional output values. The dimensional outputs are concatenated and once again projected, resulting in the final values. Due to the reduced dimension of each head, the total computational cost of the multi-head attention is similar to that of single-head attention with full dimensionality.

While FIGS. 1-4 show a configuration of components, other configurations may be used without departing from the scope of the invention. For example, various components may be combined to create a single component. As another example, the functionality performed by a single component may be performed by two or more components.

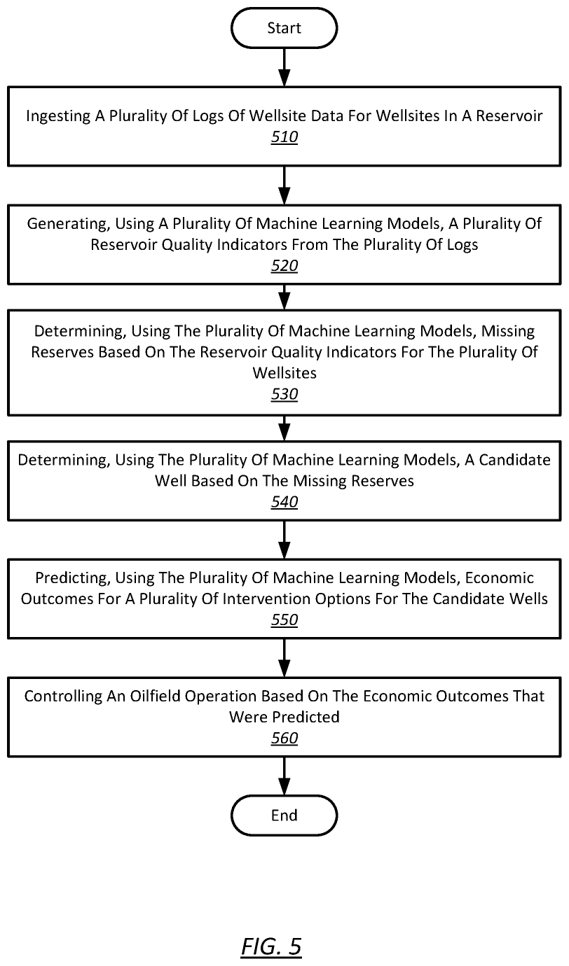

FIG. 5 shows a flowchart of method for identifying missing reserves in a reservoir in accordance with some embodiments. The method of FIG. 5 can be implemented in one or more components of the computer system illustrated in FIG. 2.

At block 510, a plurality of logs of well site data are ingested for well sites in a reservoir. It also uses other data such as well information, RCA, SCAL, PVT, and historical production data. In some embodiments, the well site data comprises a set of production curves for each of the well sites.

At block 520, a first machine learning model consumes the provided quality control inputs such as log measurements, reservoir information, well information and other physical measurements such as core and special core analysis data to generates a plurality of quality control or reconstructed log from machine learning models. Then machine learning model also produces reservoir quality indicators from the plurality of inputs.

In some embodiments, generating the plurality of reservoir quality indicators comprises generating predicting production curves for a number of possible interventions applied to the well sites. For example, interventions applied at the well sites are identified in the set of production curves; predicted curves generating for the well sites based on the set of production curves and the interventions that were identified.

At block 530, a second machine learning model determines missing reserves based on the reservoir quality indicators for the plurality of well sites. For the interval of interest if the quality trust factor is high the model uses that information, to flag or identify hydrocarbon intervals behind casing using Machine Learning. In the case of the low-quality trust factor, the model uses its own machine learning prediction module for the property prediction of the interval. In both cases machine learning model will identify missing behind casing interval opportunities (BCO) which is previously unaccounted or identified as null but have potential.

At block 540, a third machine learning model determines candidate wells based on the missing reserves. The candidate wells can be selected from existing well sites in the reservoir (i.e., wells that would benefit from an intervention), or new well slides and/or boreholes to access and identified sweet spot.

The candidate wells can be identified based on a comparison to existing wells. For example, vector representations of the well sites can be generated from the well site data. Vector similarities are then determined between the well sites using well site data collected prior to the interventions.

The trained machine learning models mentioned above use BCO, RQI and well deliverability to highlight the specific zonal level opportunity for high-quality remaining reserves. However, instead of one deterministic case used traditionally machine learning model creates hundreds of realizations by parameterizing the property values above and below the actual or predicted values providing a probabilistic map of scenario distribution. This is further used to create a stochastic remaining oil-in-place map and can be visualized in 3D geological model. It replaces the effort of running dynamic simulation model by machine learning proxies, within a fraction of the time.

At block 550, a fourth machine learning model uses provided economics for the field and predicts economic outcomes such as NPV, Rate of Return, for a plurality of intervention options for the candidate wells.

For example, the production curves for candidate wells can be extrapolated in time using the production curves of similar well sites.

At block 560, an oilfield operation can be controlled based on the predicted economic outcomes.

While the various blocks in this flowchart are presented and described sequentially, at least some of the blocks may be executed in different orders, may be combined, or omitted, and at least some of the blocks may be executed in parallel. Furthermore, the blocks may be performed actively or passively.

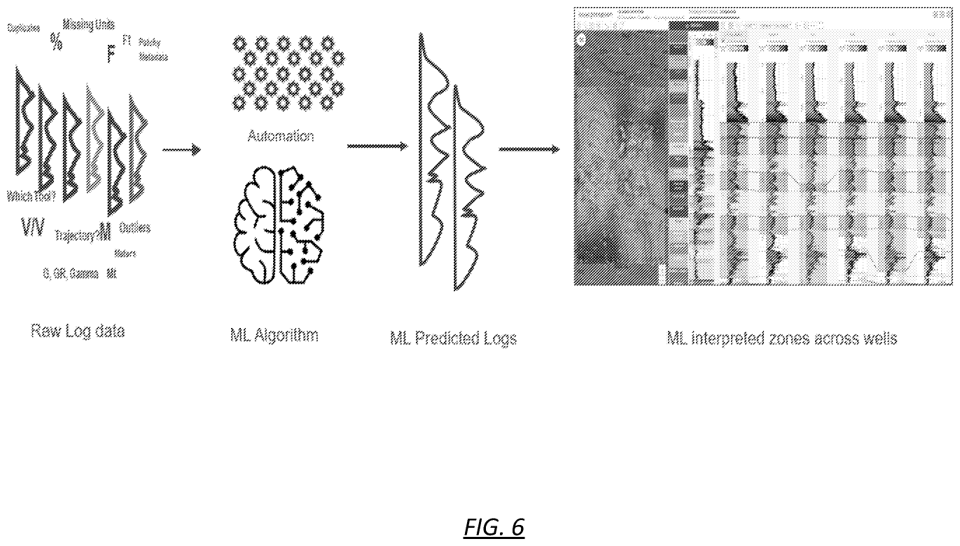

FIGS. 6-12 are examples. The examples of FIGS. 6-12 are provided for explanatory purposes only and are not intended to limit the scope of the disclosure.

FIG. 6 is an example of machine learning-assisted log quality control, and property interpretation of various zones connected between the wells. It also shows how machine learning model is used machine learning-based reservoir property generation for the areas with missing logs or missing physical measurements. This can help to identify missing reserves opportunities in between the wells.

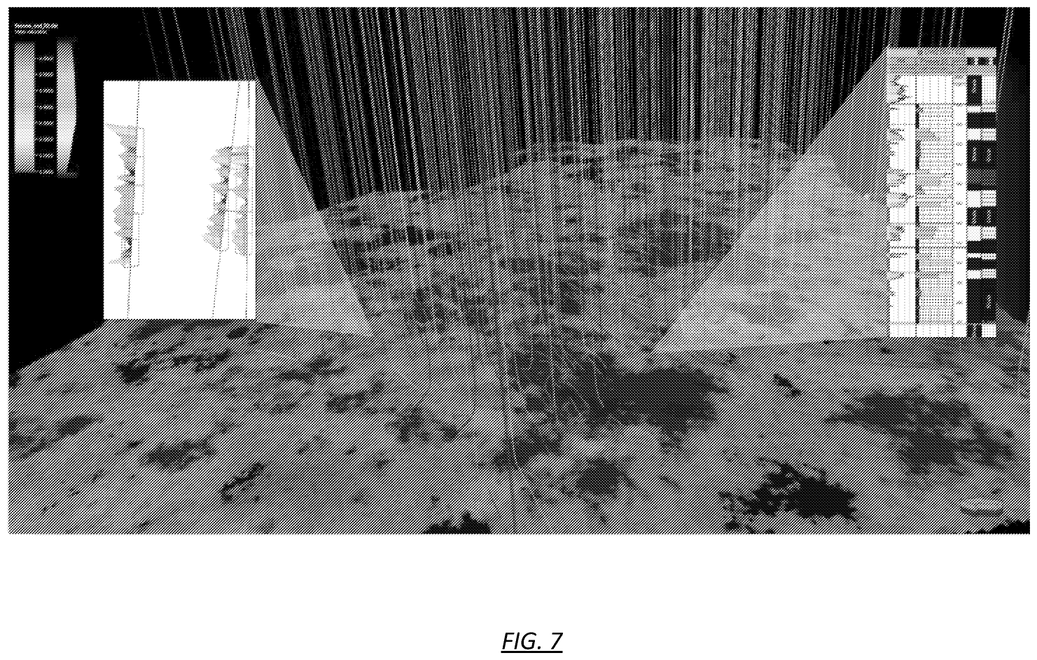

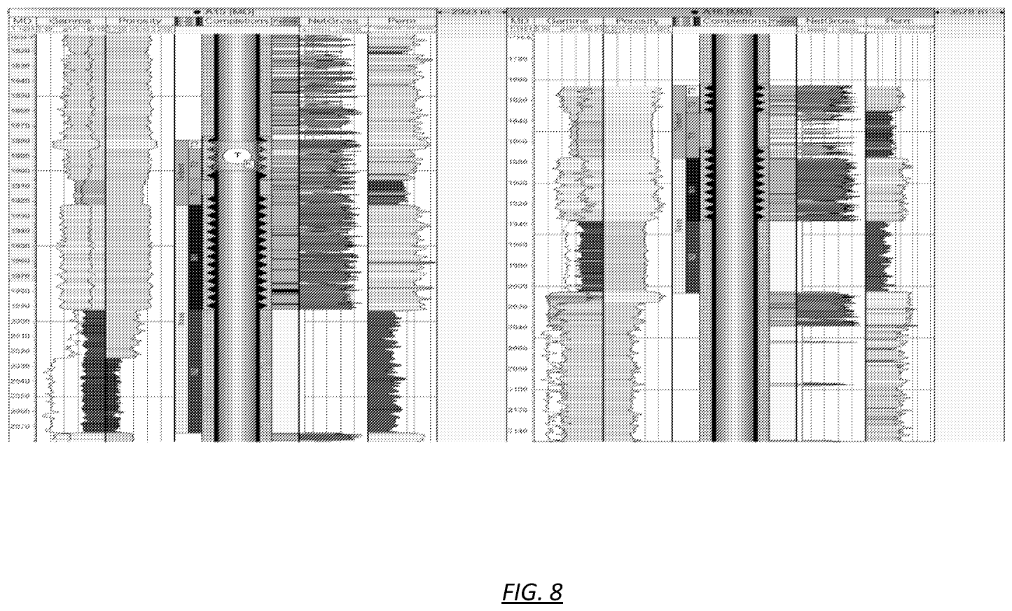

FIG. 7 and FIG. 8 show an example of the evaluation of reservoir quality indicators (RQI) for wells and the distribution of properties indicator overall quality based on the measurement.

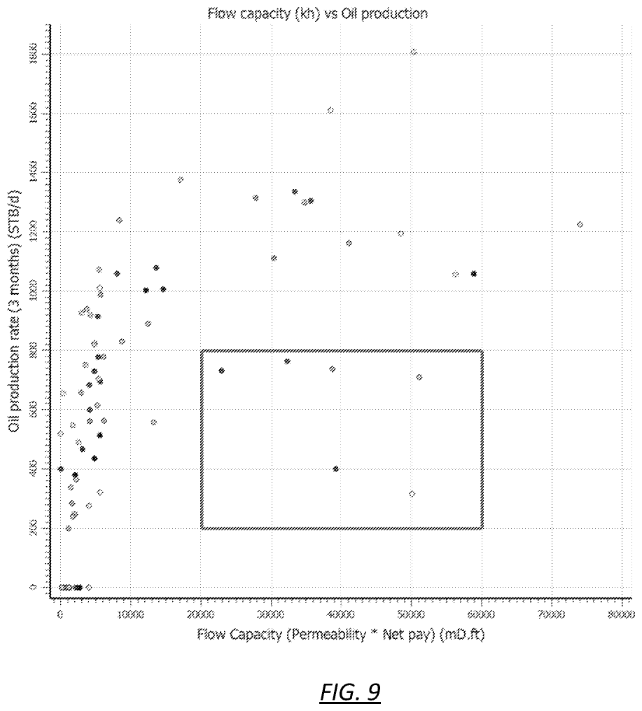

FIG. 9 is an example of a map of the reservoir quality index vs the average of actual production rate over 3 months. The production rate variable can be changed for an average of 6 months or a year or more depending on the study requirement. Machine learning models can create an ensemble of various such realizations to map to be analyzed for high-potential wells that are not fully produced. This could be an opportunity to dig deeper and identify as a candidate for missing reserves.

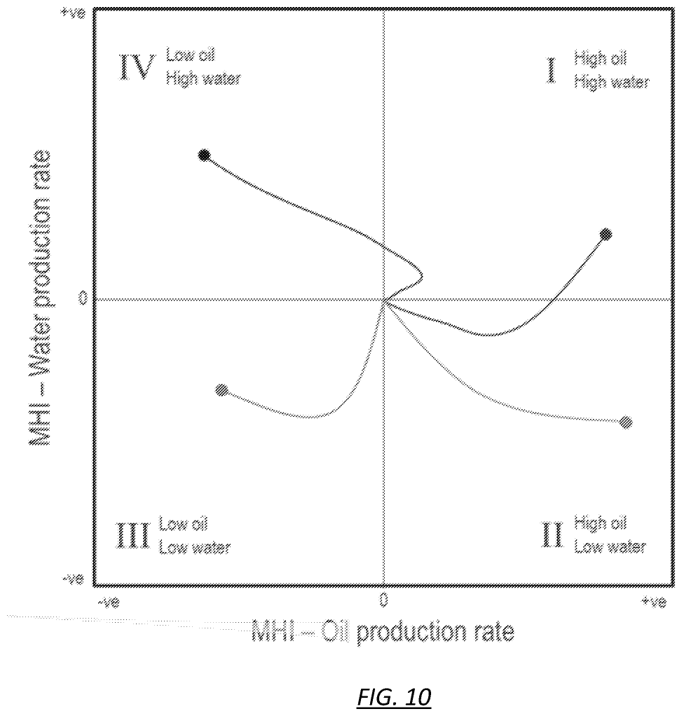

FIG. 10 is an example of a traditional heterogeneity analysis map of oil production rate vs water production rate to validate potential well candidates. The aim is to pick well with high oil production with a lower water production trend.

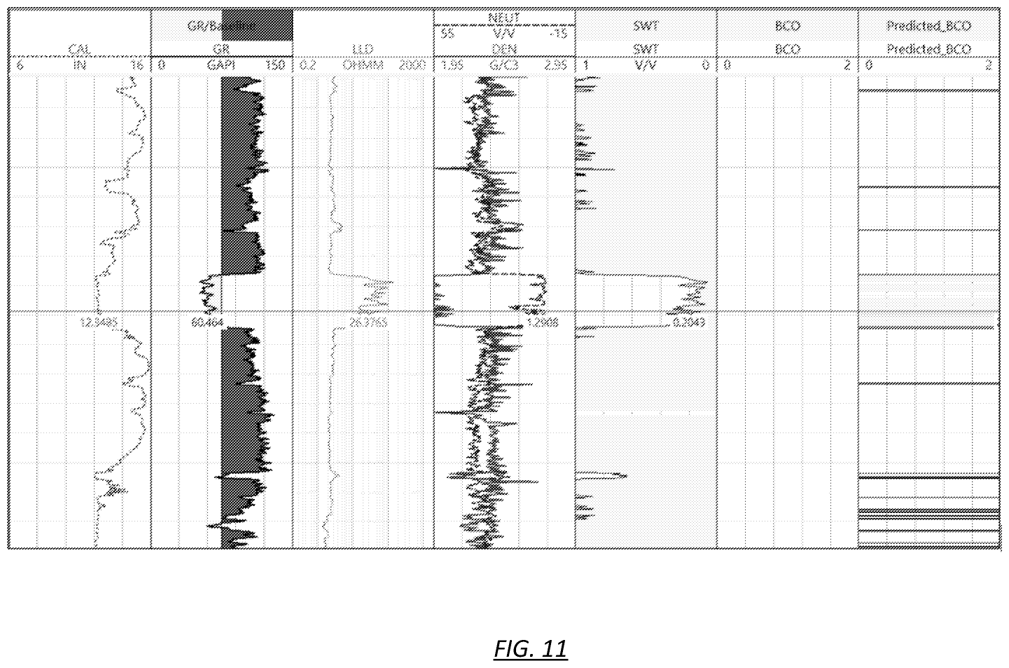

FIG. 11 is an example showing a potential additional thicker layer identified by the machine learning algorithms with higher confidence, supported by the SWT curve. Predicted BCO can have its low, mid, high confidence level that can be validated and approved by the domain experts.

FIG. 12 is an example of heat maps for missing reserves identified within a reservoir. The maps compare results generated by a traditional Bayesian model with results generated by one or more machine learning models, such as machine learning model(s) (206) of FIG. 2. As illustrated, estimations by the AI system may identify opportunity zones within a reservoir more quickly and accurately as compared with traditional statistical methods.

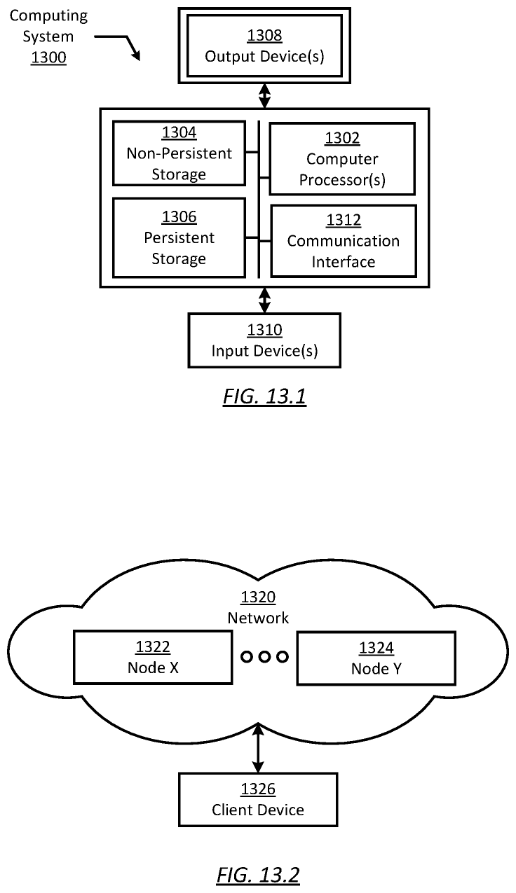

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 13.1, the computing system (1300) may include one or more computer processor(s) (1302), non-persistent storage (1304), persistent storage (1306), a communication interface (1312) (e.g., Bluetooth interface, infrared interface, network interface, optical interface, etc.), and numerous other elements and functionalities that implement the features and elements of the disclosure. The computer processor(s) (1302) may be an integrated circuit for processing instructions. The computer processor(s) may be one or more cores or micro-cores of a processor. The computer processor(s) (1302) includes one or more processors. The one or more processors may include a central processing unit (CPU), a graphics processing unit (GPU), a tensor processing unit (TPU), combinations thereof, etc.

The input devices (1310) may include a touchscreen, keyboard, mouse, microphone, touchpad, electronic pen, or any other type of input device. The input devices (1310) may receive inputs from a user that are responsive to data and messages presented by the output devices (1308). The inputs may include text input, audio input, video input, etc., which may be processed and transmitted by the computing system (1300) in accordance with the disclosure. The communication interface (1312) may include an integrated circuit for connecting the computing system (1300) to a network (not shown) (e.g., a local area network (LAN), a wide area network (WAN) such as the Internet, mobile network, or any other type of network) and/or to another device, such as another computing device.

Further, the output devices (1308) may include a display device, a printer, external storage, or any other output device. One or more of the output devices may be the same or different from the input device(s). The input and output device(s) may be locally or remotely connected to the computer processor(s) (1302). Many distinct types of computing systems exist, and the aforementioned input and output device(s) may take other forms. The output devices (1308) may display data and messages that are transmitted and received by the computing system (1300). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (1300) in FIG. 13.1 may be connected to or be a part of a network. For example, as shown in FIG. 13.2, the network (1320) may include multiple nodes (e.g., node X (1322), node Y (1324)). Each node may correspond to a computing system, such as the computing system shown in FIG. 13.1, or a group of nodes combined may correspond to the computing system shown in FIG. 13.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1300) may be located at a remote location and connected to the other elements over a network.

The nodes (e.g., node X (1322), node Y (1324)) in the network (1320) may be configured to provide services for a client device (1326) including receiving requests and transmitting responses to the client device (1326). For example, the nodes may be part of a cloud computing system. The client device (1326) may be a computing system, such as the computing system shown in FIG. 13.1. Further, the client device (1326) may include and/or perform all or a portion of one or more embodiments of the invention.

The computing system of FIG. 13.1 may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and blocks shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the term “or” is an “inclusive or” and, as such includes the term “and.” Further, items joined by the term “or” may include any combination of the items with any number of each item unless, expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method for identifying missing reserves in a reservoir, the method comprising, comprising:
ingesting a plurality of logs of well site data for well sites in a reservoir;
generating, by a first machine learning model, a plurality of behind casing opportunities from the plurality of logs;
determining, by a second machine learning model, missing reserves based on the reservoir quality indicators for the plurality of well sites;
determining, by a third machine learning model, candidate wells based on the missing reserves;
predicting, by a fourth machine learning model, economic outcomes and for ranking a plurality of intervention options for the candidate wells; and
controlling an oilfield decision based on the predicted economic outcomes.

2. The method of claim 1 wherein the well site data comprises a set of log curves for each of the well sites.

3. The method of claim 2 comprising:
identifying interventions applied at the well sites in the set of log curves, production curves, core data and Special core analysis data SCAL data;
generating predicted reservoir quality index for each well and pay zones within well sites based on the set of reservoir and production data and the interventions that were identified.

4. The method of claim 3 comprising extrapolating each of the reservoir quality index, to identify missing reserves in between the wells and specific pay zone in time prior to the interventions using the production curves and reservoir quality index of similar well sites.

5. The method of claim 2 comprising:
generating vector representations of the well sites; and
determining similarities between the well sites prior to the interventions.

6. The method of claim 1, wherein the candidate wells are selected from existing well sites in the reservoir.

7. The method of claim 1, wherein the candidate wells are new well sites in the reservoir.

8. A computer program product comprising:
a non-transitory computer-readable storage media having program code stored thereon that, when executed by a computer processor of a computing system, cause the computing system to perform the method of:
ingesting a plurality of logs of well site data for well sites in a reservoir;
generating, by a first machine learning model, a plurality of behind casing opportunities from the plurality of logs;
determining, by a second machine learning model, missing reserves based on the reservoir quality indicators for the plurality of well sites;
determining, by a third machine learning model, candidate wells based on the missing reserves;
predicting, by a fourth machine learning model, economic outcomes and for ranking a plurality of intervention options for the candidate wells; and
controlling an oilfield decision based on the predicted economic outcomes.

9. The computer program product of claim 8 wherein the well site data comprises a set of production curves for each of the well sites.

10. The computer program product of claim 9, further comprising:
identifying interventions applied at the well sites in the set of production curves; and
generating predicted curves for the well sites based on the set of production curves and the interventions that were identified.

11. The computer program product of claim 10 further comprising:
extrapolating each of the production curves in time prior to the interventions using the production curves of similar well sites.

12. The computer program product of claim 9 further comprising:
generating vector representations of the well sites; and
determining similarities between the well sites prior to the interventions.

13. The computer program product of claim 8, wherein the candidate wells are selected from existing well sites in the reservoir.

14. The computer program product of claim 8, wherein the candidate wells are new well sites in the reservoir.

15. A system comprising:
a computer processor;
memory; and
instructions stored in the memory and executable by the computer processor to cause the computer processor to perform operations, the operations comprising:
ingesting a plurality of logs of well site data for well sites in a reservoir;
generating, by a first machine learning model, a plurality of behind casing opportunities from the plurality of logs;
determining, by a second machine learning model, missing reserves based on the reservoir quality indicators for the plurality of well sites;
determining, by a third machine learning model, candidate wells based on the missing reserves;
predicting, by a fourth machine learning model, economic outcomes and for ranking a plurality of intervention options for the candidate wells; and
controlling an oilfield decision based on the predicted economic outcomes.

16. The system of claim 15, wherein the well site data comprises a set of production curves for each of the well sites.

17. The system of claim 16, further comprising:
identifying interventions applied at the well sites in the set of production curves; and
generating predicted curves for the well sites based on the set of production curves and the interventions that are identified.

18. The system of claim 17, further comprising extrapolating each of the production curves in time prior to the interventions using the production curves of similar well sites.

19. The system of claim 16, further comprising:
generating vector representations of the well sites; and
determining similarities between the well sites prior to the interventions.

20. The system of claim 16, wherein the candidate wells are at least one of: selected from existing well sites in the reservoir and are new well sites in the reservoir.

21. (canceled)
